(19) United States
(12) Patent Application Publication
(10) Pub. No.: US 2006/0235826 A1
(43) Pub. Date: Oct. 19, 2006

(54) Tasking, invoicing, and reporting methods

(75) Inventor: Tina M. Lance, Spotsylvania, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: United States Postal Service

(21) Appl. No.: 11/402,992

(22) Filed: Apr. 13, 2006

Related U.S. Application Data
(60) Provisional application No. 60/671,453, filed on Apr. 15, 2005.

(51) Int. Cl. G06F 17/30; G06F 7/00; G06Q 99/00; H04L 9/00; H04K 1/00

(52) U.S. Cl. 707/1; 705/80

(57) ABSTRACT

Methods and systems for managing projects and budgets, such as advertising projects and budgets, in a database, and generating reports corresponding to data stored in the database. Actions may include associating tasks with a project in a dependent many-to-one relationship; associating budget categories with the tasks in a one-to-many relationship; associating resource with projects in a non-specific relationship; and generating reports about at least one of the tasks, budget categories associated with the tasks, and invoices associated with the tasks, based on user-supplied criteria. Indicia of each relationship may be stored in the database.

### RELATED APPLICATION

This application claims benefit of U.S. Provisional Application No. 60/671,453 filed Apr. 15, 2005, entitled “Advertising Accounting and Tracking Method,” which is incorporated herein by reference in its entirety.

### TECHNICAL FIELD

The invention relates generally to methods for tasking, invoicing, and reporting for multiple ongoing and planned projects, and more particularly, to tasking, invoicing, and reporting on various aspects of marketing campaigns and associated budgets.

### BACKGROUND

Business entities must frequently account for their expenditures, manage costs, and increase returns on investments. Such business entities may rely on software tools, such as project management tools and databases, to account for and quickly report on multiple budgets, multiple campaigns or projects, multiple resources, multiple customer segments, etc., all of which may be interrelated or associated in various connectivity relationships.

Connectivity relationships, as used herein, may include “one-to-one,” “one-to-many,” and “many-to-many” (i.e., non-specific) relationships. Connectivity relationships are used to describe relationships between instances of data entities (i.e., records) stored in a database. A one-to-one relationship, for example, uniquely maps or associates an instance of a first data entity with an instance of a second data entity and vice-versa. For example, employees in an office building are typically associated with telephone numbers in a one-to-one relationship. Thus, for each employee there exists a unique number, and for each number there exists a unique employee. In a database that tracks employees, the employee's name and/or ID (i.e., an instance of an employee data entity) would likely be associated with a telephone number (i.e., an instance of a telephone number data entity) in a one-to-one relationship.

A one-to-many relationship differs in that it maps one instance of a first data entity to zero, one, or many instances of a second data entity. For example, one floor of an office building may be associated with zero offices (e.g. a lobby), one office (e.g., a CEO suite), or many offices existing on that floor. Each office, however, is uniquely associated with only one floor. Also, a one-to-many relationship (or many-to-one relationship, as the case may be) may also include a dependency relationship, where one data entity is a parent of many children data entities.

A many-to-many relationship maps zero, one, or many instances of a first data entity to zero, one, or many instances of a second data entity. More specifically, for one instance of the first data entity, there exist zero, one, or many instances of the second data entity; conversely, for one instance of the second data entity, there exist zero, one, or many instances of the first data entity. An example of a many-to-many relationship is employees and projects. That is, an employee may be assigned to zero, one, or many projects. Conversely, a single project may have zero, one, or many assigned employees, each of whom are not necessarily assigned to the single project alone. Thus, a many-to-many relationship may also be called a non-specific relationship.

Data and records that are stored and associated with each other by connectivity relationships in a database system may be monitored, updated, and modified constantly by various parties. Moreover, access may be managed appropriately so that certain data is accessible to only certain parties with certain levels of access permissions (e.g., create, read, write, delete, approve, etc.). Thus, it is desirable to maintain a database for a business entity that is secure, reliable, and capable of storing and interrelating large amounts of data retrieved from various sources, both local and remote, but which is also flexible and easy to manage, operate, and access. The appropriate balance of each of these factors is often difficult to achieve, given the wide variety of business contexts that exist.

For example, a marketing organization often handles various advertising projects or efforts (e.g., advertising campaigns), which may require complex accounting and budgeting plans composed of various stages or tasks. In addition, a marketing organization may enlist the help of various agencies or suppliers (i.e., labor resources) in carrying out its marketing efforts and tasks. An efficient and easily accessible advertising accounting and tracking system is desirable to provide a proposal and approval process for tasks associated with multiple projects across multiple budget categories, to track costs and invoices associated with the tasks, and to produce meaningful reports based on selectable criteria, reflecting the effectiveness of the tasks and overall projects. A comprehensive, dynamic, online tasking and invoicing solution that provides a framework to manage large complex budgets across multiple agencies, products and mediums is therefore desirable. Current software tools and databases lack the flexibility and features needed to serve these ends.

In addition, Section 404 of the Sarbane-Oxley Act of 2002 requires internal control structures and processes for financial reporting, often of particular concern to marketing organizations due to the high amounts of discretionary spending often associated with them. Thus, marketing organizations have an increasingly vital need for automated systems to plan, budget, execute, and measure the impact of marketing efforts more effectively.

### SUMMARY

Embodiments consistent with the invention provide methods and systems for managing projects and budgets, such as advertising projects and budgets, in a database and generating reports on the data stored in the database.

Embodiments include methods and systems for managing projects in a database, comprising operations and apparatus for associating tasks with a project in a dependent many-to-one relationship and associating budget categories with the tasks in a one-to-many relationship. Operations and apparatus may further include associating resources with projects in a non-specific relationship, associating the resources with cost categories in a non-specific relationship, and associating the resources with rates in a one-to-many relationship. Indicia of each relationship may be stored in the database.

Advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is an exemplary main interface of a project management application consistent with the invention;

FIG. 2 is a general overview of how data may be organized and interrelated in a database consistent with the invention;

FIG. 3 is an exemplary campaign list interface consistent with the invention, which may be accessible by selecting a menu option on the main interface depicted in FIG. 1;

FIG. 4 is an exemplary add campaign interface consistent with the invention, which may be accessible by selecting a menu option on the campaign list interface depicted in FIG. 3;

FIG. 5 is an exemplary campaign details interface consistent with the invention, which may be accessible by selecting a menu option on the campaign list interface depicted in FIG. 3;

FIG. 6 is an exemplary add task interface consistent with the invention, which may be accessible by selecting a menu option on the campaign details interface depicted in FIG. 5;

FIG. 7 is an exemplary add invoice interface consistent with the invention, which may be accessible via selection of a task on the campaign details interface depicted in FIG. 5;

FIG. 8 is an exemplary maintenance interface consistent with the invention, which may be accessible by selecting a menu option on the main interface depicted in FIG. 1;

FIG. 9 is an exemplary budget category editing interface consistent with the invention, which may be accessible by selecting a menu option on the maintenance interface depicted in FIG. 8;

FIG. 10 is an exemplary add budget category interface consistent with the invention, which may be accessible by selecting a menu option on the budget category editing interface depicted in FIG. 9;

FIG. 11 is an exemplary agency editing interface consistent with the invention, which may be accessible by selecting a menu option on the maintenance interface depicted in FIG. 8;

FIG. 12 is an exemplary edit agency parameters interface consistent with the invention, which may be accessible by selecting a menu option on the agency editing interface depicted in FIG. 11;

FIG. 13 is an exemplary edit cost categories interface consistent with the invention, which may be accessible by selecting a menu option on the edit agency parameters interface depicted in FIG. 12;

FIG. 14 is an exemplary edit rates interface consistent with the invention, which may be accessible by selecting a menu option on the edit agency parameters interface depicted in FIG. 12;

FIG. 15 is an exemplary reporting interface consistent with the invention, which may be accessible by selecting a menu option on the main interface depicted in FIG. 1;

FIG. 16 is an exemplary report criteria interface consistent with the invention, which may be accessible by selecting a menu option on the reporting interface depicted in FIG. 15; and

FIG. 17 is an exemplary report details interface consistent with the invention, which may be accessible by selecting a menu option on the report criteria interface depicted in FIG. 16.

### DETAILED DESCRIPTION

A business entity may manage various ongoing and/or planned projects, such as marketing or advertising campaigns, using a project management application for implementing methods consistent with the present invention. The project management application and databases referenced in the following description may be implemented using one or more general purpose or specialized computers configured in a network. The network may be accessible via an Internet connection.

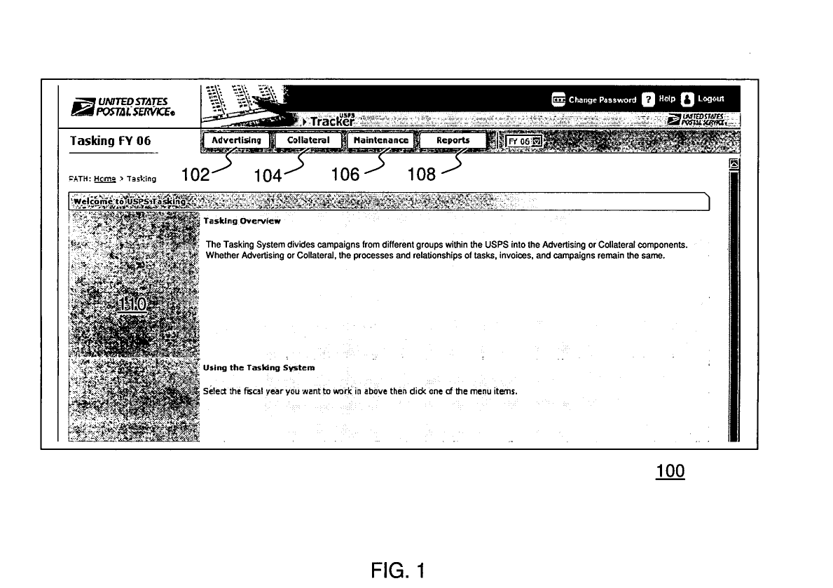

FIG. 1 is an exemplary main interface 100 that the project management application may present to a user. For security, authentication, and access permissions management purposes, a user may be required to login to the project management application prior to accessing main interface 100. For example, managing users (i.e., users representing the business entity) may be permitted access to certain data that is restricted from agency users (i.e., users representing labor resources enlisted by the business entity). Moreover, various levels of access may exist for different managing users and different agency users.

Main interface 100 may include an upper pane with various menu options 102-108 for user selection and a lower pane displaying an introductory message 110. Introductory message 110 may include an overview or guide for users of the project management application. The upper pane may be a permanent pane, thereby providing user access to menu options 102-108 at any time while navigating through various interfaces presented by the project management application. Menu options 102-108 may include advertising option 102, collateral option 104, maintenance option 106, and report option 108, corresponding, respectively, to an advertising budget module, a collateral budget module, a maintenance module, and a reporting module. Applications and methods associated with each of options 102-108 are explained below.

I. Advertising/Collateral Modules

User selection of advertising option 102 or collateral option 104 may provide user access to an advertising module or a collateral module, respectively, of the project management application. The advertising module may include applications and interfaces that enable a user to enter, modify, and review data associated with an advertising budget. The collateral module may include similar applications and interfaces for managing a collateral budget separate and distinct from the advertising budget.

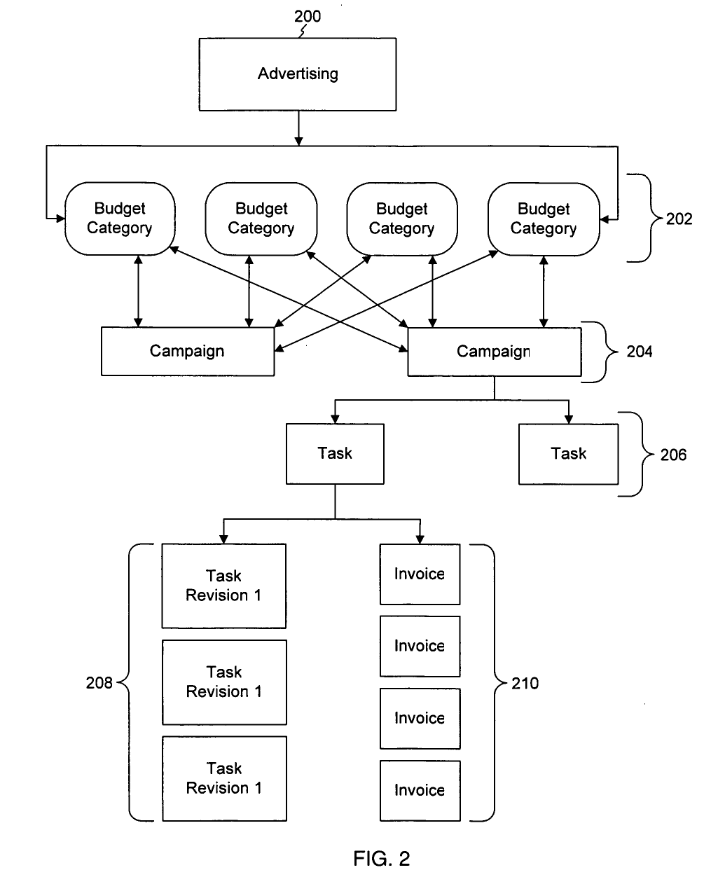

FIG. 2 is a general overview of how data may be organized and interrelated in one or more databases accessed by the project management application. Although FIG. 2 depicts data associated with an advertising budget 200, a similar organization of data may exist for a collateral budget.

Advertising budget 200 may be a business entity's fiscal year budget and may include various budget categories 202. A managing user in the business entity may define budget categories 202 and may allot various amounts or percentages of advertising budget 200 to each budget category 202. Budget categories 202 may be associated with various campaigns 204 in need of funding. Campaigns 204 may also be defined by the managing user.

Each of campaigns 204 may include one or more tasks 206. Tasks 206 may be associated with campaigns 204 in a database with a many-to-one dependent relationship. Tasks 206 may be defined by users from an agency enlisted by the business entity to promote or advertise any number of products and/or services offered by the business entity. Alternatively, tasks 206 may be jointly defined by the agency users and managing users from the business entity. In defining tasks 206, various task revisions 208 may be automatically created to allow later editing without reentering key details. For example, a dollar amount associated with labor for one of tasks 206 may be changed and the revised task may be stored as one of task revisions 208. Tasks 206 may undergo various revisions before an enlisted agency (not shown) creates a deliverable (not shown). Deliverables, such as media ads (e.g., television and/or radio) or paper ads (e.g., pamphlets, brochures, banners, and/or mail pieces), may be associated with one campaign, but may be designed to promote multiple products and/or services offered by the business entity.

Various invoices 210 may be created by an agency when labor is performed on tasks 206 or task revisions 208. Invoices 210 as well as task revisions 208 may be submitted in various stages by agencies, and each stage may undergo an approval process within the business entity. In this manner, the business entity may maintain close oversight on task revisions 208 and invoices 210 and may conveniently maintain a detailed record of planned work and actual work performed on campaigns 204.

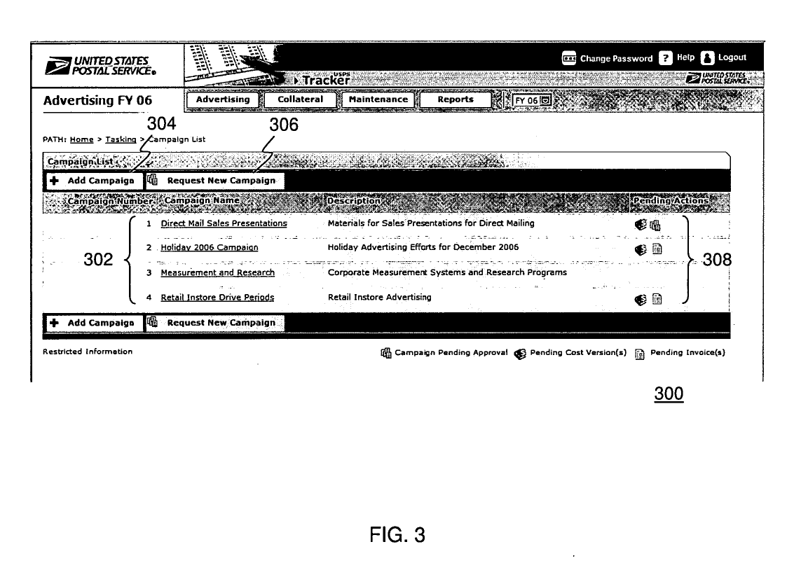

FIG. 3 is an exemplary campaign list interface 300 displayed by the project management application when a user selects advertising option 102 on main interface 100 shown in FIG. 1. Campaign list interface 300 may include a list of names 302 of various advertising campaigns, their associated descriptions, and pending actions. Campaign list interface 300 may also include an add campaign option 304 for creating new campaigns and a request new campaign option 306 for submitting campaign descriptions for approval. For instance, managing users may add new campaigns using add new campaign option 304 while agency users may be limited to requesting new campaigns via request new campaign option 306. Various pending actions 308 may also be associated with each of the campaigns.

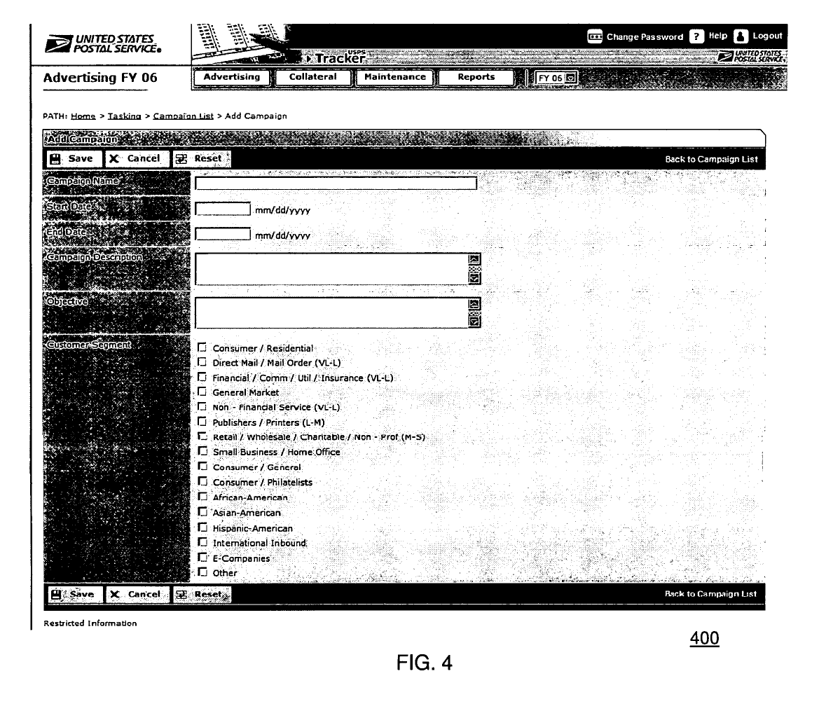

FIG. 4 is an exemplary add campaign interface 400 displayed by the project management application when a managing user selects add campaign option 304 on campaign list interface 300 shown in FIG. 3. The project management application may display a similar interface when a managing user selects request new campaign option 306 shown in FIG. 3. In adding or requesting a new campaign, a user may define the following attributes: a campaign name, a start date, an end date, a description, an objective, and one or more customer segments served or targeted by the campaign. Customer segments may be associated with a campaign in a many-to-many relationship. That is, zero, one, or multiple customer segments may exist in a non-specific relationship with each campaign.

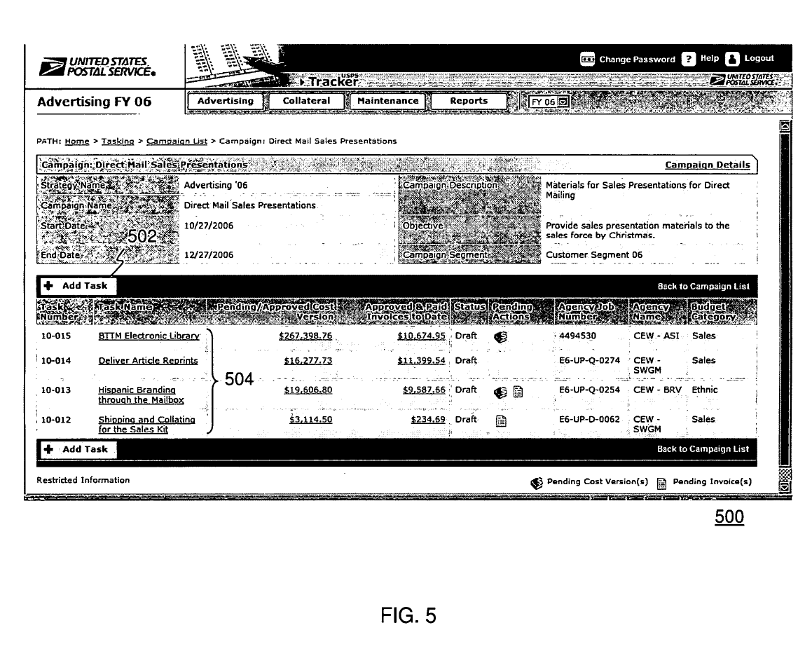

FIG. 5 is an exemplary campaign details interface 500, which may be displayed when a user selects a campaign's name 302 from campaign list interface 300. In an upper pane of campaign details interface 500, various attributes of the selected campaign such as name, start date, end date, etc., may be displayed. A lower pane of campaign details interface 500 may display a table of tasks including a task name list 504, associated with the selected campaign. An add task option 502 may be available for a user, often an agency user, to add (or propose for approval) new tasks to a campaign.

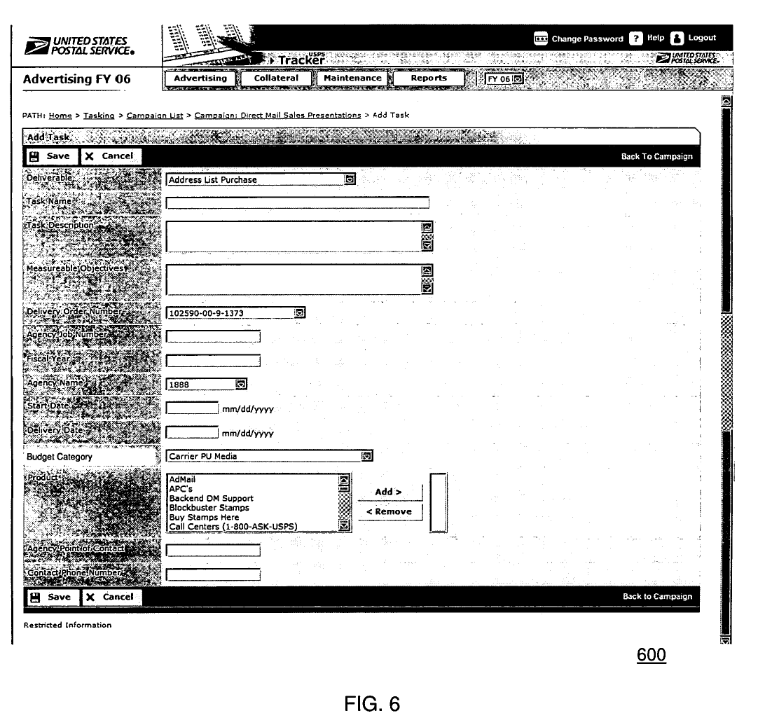

FIG. 6 is an exemplary add task interface 600 displayed by the project management application when an agency user selects add task option 502 from campaign details interface 500. Add task interface 600 may include various fields for user entry and/or user selection from lists. For example, the following data or attributes may be associated with a task: a task deliverable, a task name, a task description, measurable objectives, a delivery order number, an agency (i.e., labor resource) job number, a fiscal year, an agency name, a start date, a delivery date, a budget category, a product, an agency point of contact, and the contact's phone number. Exemplary products may include services as well as tangible products. Like other interfaces of the project management application, data entered via add task interface 600 may be stored in a database for future access and/or modification. The entered data may be associated with tasks in various connectivity relationships as indicated in add task interface 600. For example, deliverables, budget categories, and agencies may each be associated with tasks in a one-to-many relationship, whereas products (and/or services), may be associated with tasks in a many-to-many relationship.

Upon being submitted, a task may be assigned a status and may undergo an approval process. First, the project management application may assign the task a “draft” status until it has been submitted to a business entity user for approval. The task status may be “pending” once it has been submitted for review, “approved” after each appropriate business entity use has okayed the task, “denied” if the task does not meet the needs of the business entity, and “closed” after the task has been completed. After a task has been denied, a submitting agency user may edit and/or resubmit the task. If a task has been entered incorrectly or a project's scope has changed, a “void” status may remove the task from the approval process and from any corresponding budget or report calculations.

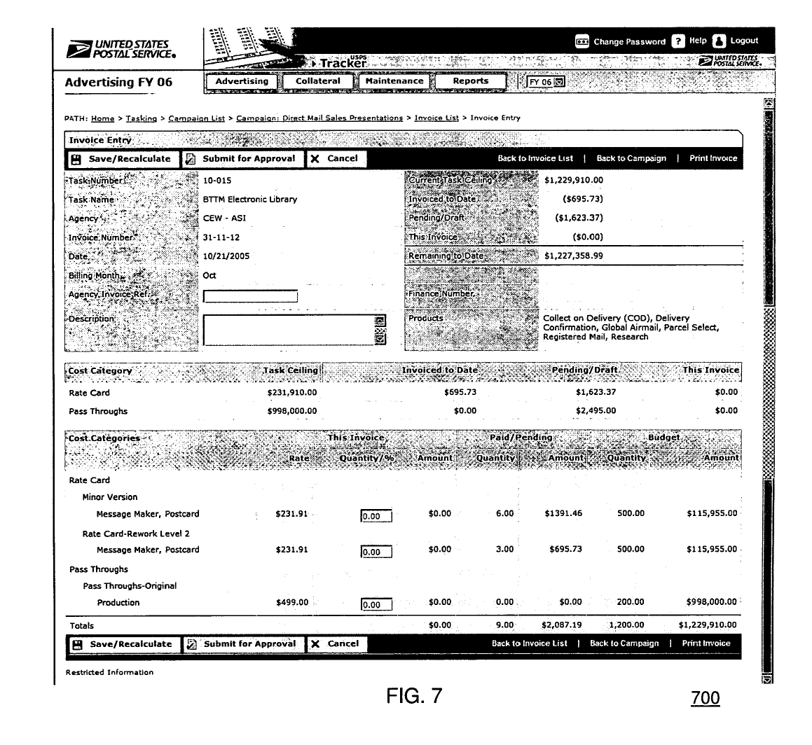

FIG. 7 is an exemplary add invoice interface 700 displayed by the project management application to permit an agency user to create an invoice for labor or service rendered on a task. For example, an agency user may select a task from task name list 504 on campaign details interface 500 and an add invoice option from a task details interface (not shown). Add invoice interface 700 may include various fields such as an agency invoice number, a description, and dollar quantities corresponding to one or more cost categories associated with the invoice submitting agency.

Each invoice may undergo an approval process similar to that described above for tasks. Users that approve or disapprove an invoice may be a limited group of authorized users. In addition, options may also be provided on other interfaces to permit users to manage invoices, including adding, editing, viewing, voiding, printing, and viewing approval or disapproval notices associated with an invoice. An interface may also be provided for a managing user to review and automatically pay approved invoices electronically.

II. Maintenance Module

The project management application may include a maintenance module, which may permit a business entity user, such as a system administrator, to create, maintain, and review various functions and data in the project management application. For example, the maintenance module may permit a system administrator to maintain user logon accounts, define and edit budget categories, assign task and campaign approving users, create and revise agency information, edit specific invoices, and various other maintenance functions.

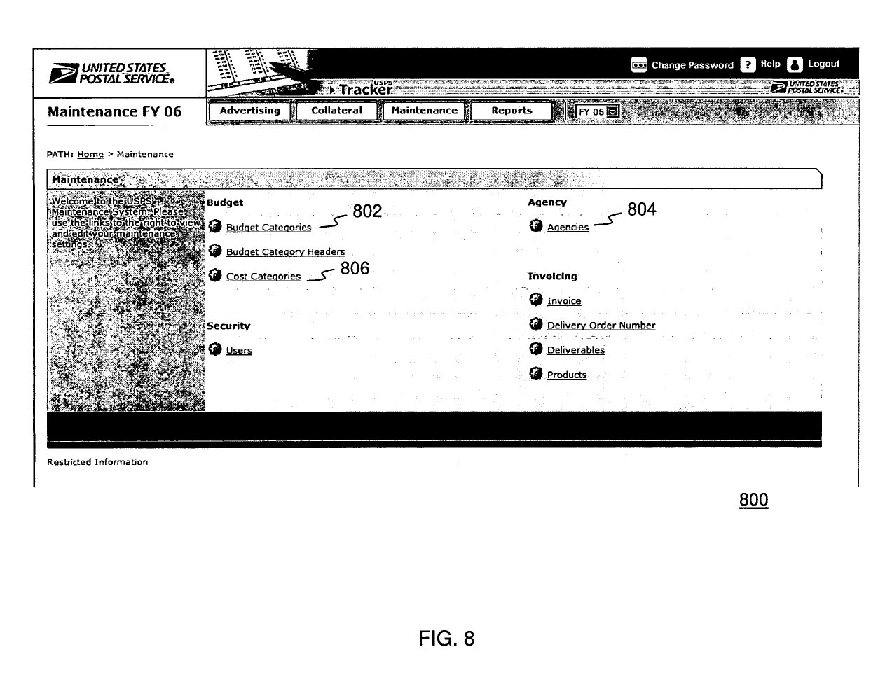

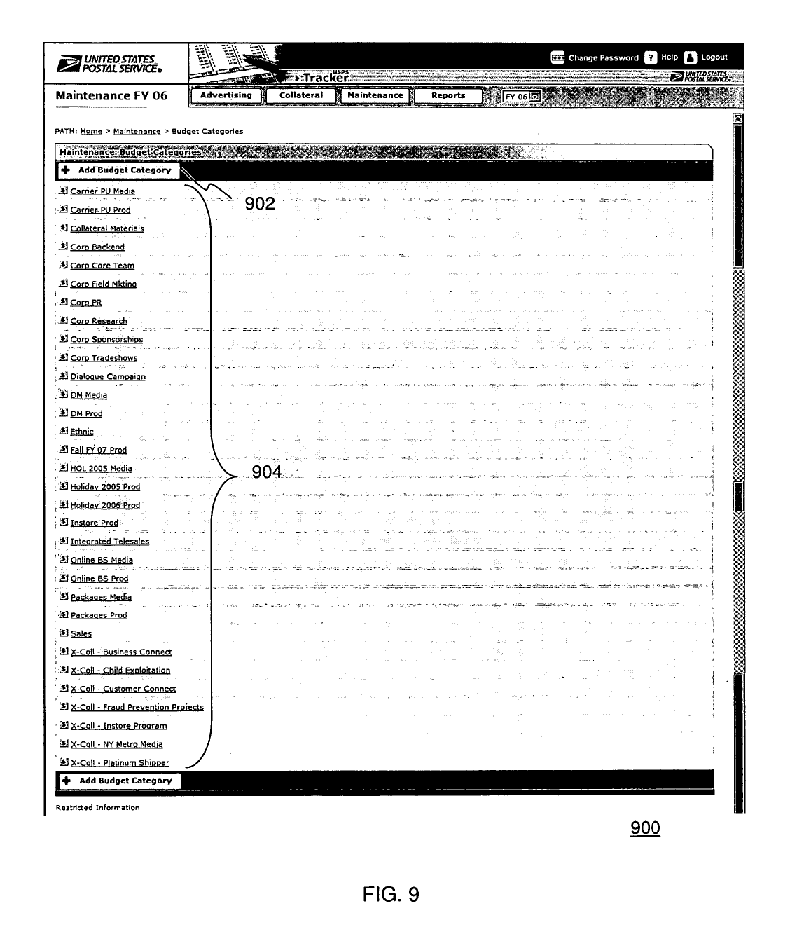

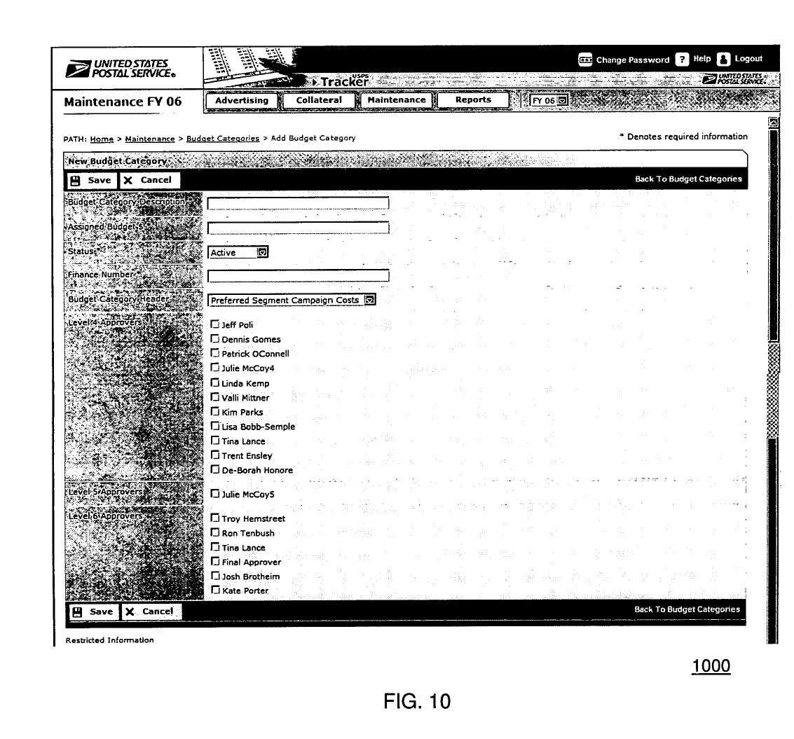

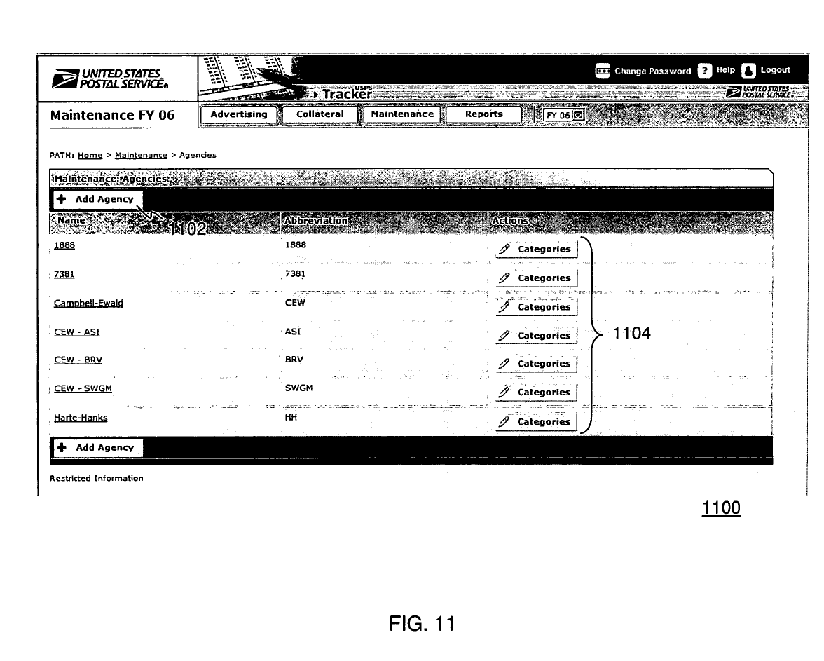

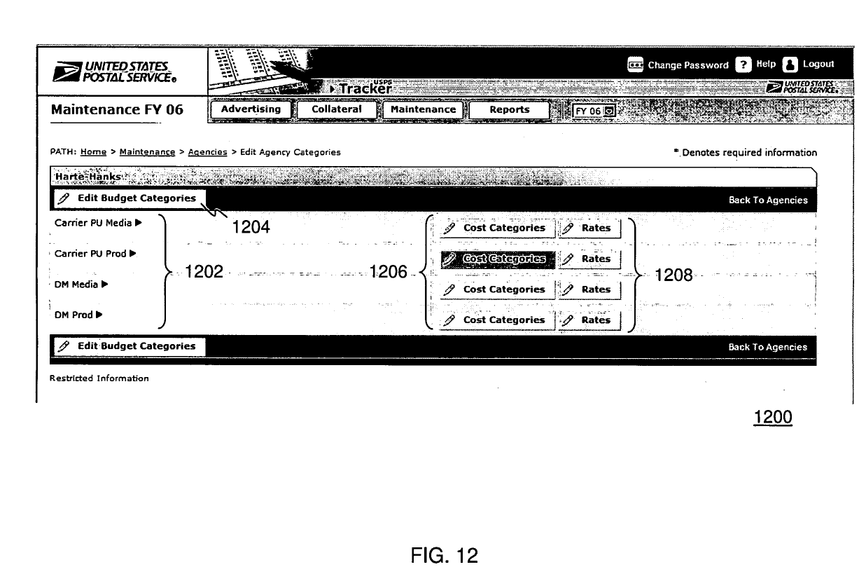

FIG. 8 is an exemplary maintenance interface 800 displayed by the project management application when a managing user selects maintenance option 106 from main interface 100. Various options, including options 802-806, may be presented to allow users with appropriate permissions to define new and revise existing budget categories, cost categories, user profiles, agencies, invoices, deliverables, and products, among other things. FIGS. 9 and 10 are exemplary interfaces displayed upon selection of a budget category option 802. FIGS. 11 and 12 are exemplary interfaces displayed upon selection of an agency option 804. Cost categories associated with agencies may be defined by a managing user via cost categories option 806 and are further explained below in reference to FIG. 12.

FIG. 9 is an exemplary budget category editing interface 900 displayed by the project management application when a managing user selects budget category option 802 from maintenance interface 800. Budget category editing interface 900 may include an add budget category option 902 and a budget category list 904. Selecting a budget category from budget category list 904 may cause attributes associated with the selected budget category to be displayed for review and/or revision.

FIG. 10 is an exemplary add budget category interface 1000 displayed by the project management application when a managing user selects add budget category option 902 from budget category editing interface 900. Add budget category interface 1000 may include various fields for user entry and/or user selection from a list. For example, the following data or attributes may be associated with a budget category: a description, an assigned budget dollar amount, a status (e.g., active, inactive, checked, unchecked, draft, pending, closed, approved, denied, submitted, void, reconciled, or paid), a finance number, a header, and approving users of varying approval levels. Data entered via add budget category interface 1000 may be stored in a database for future access and/or modification. The entered data may be associated with budget categories in various connectivity relationships as indicated in add budget category interface 1000. For example, status values may be associated with budget categories in a one-to-many relationship, whereas approving users may be associated with budget categories in a many-to-many relationship.

FIG. 11 is an exemplary agency editing interface 1100 displayed by the project management application when a managing user selects agency option 804 from maintenance interface 800. Agency editing interface 1100 may include an add agency option 1102 above a list of existing agency names and a list of corresponding agency abbreviations. Agency interface may also include category options 1104 for each listed agency, which a managing user may select to define, edit, or view various parameters associated with each agency.

FIG. 12 is an exemplary edit agency parameters interface 1200 displayed by the project management application when a managing user selects one of category options 1104 from agency editing interface 1100. Edit agency parameters interface 1200 may include a budget categories list 1202 corresponding to a selected agency and an edit budget categories option 1204. Edit budget categories option 1202 may permit user selection of one or more budget categories to associate with an agency in a database. The budget categories to be selected may be predefined using add budget category interface 1000 depicted in FIG. 10. Various cost categories and billing rates may be associated with each budget category in budget categories list 1202 using cost categories options 1206 and rates options 1208.

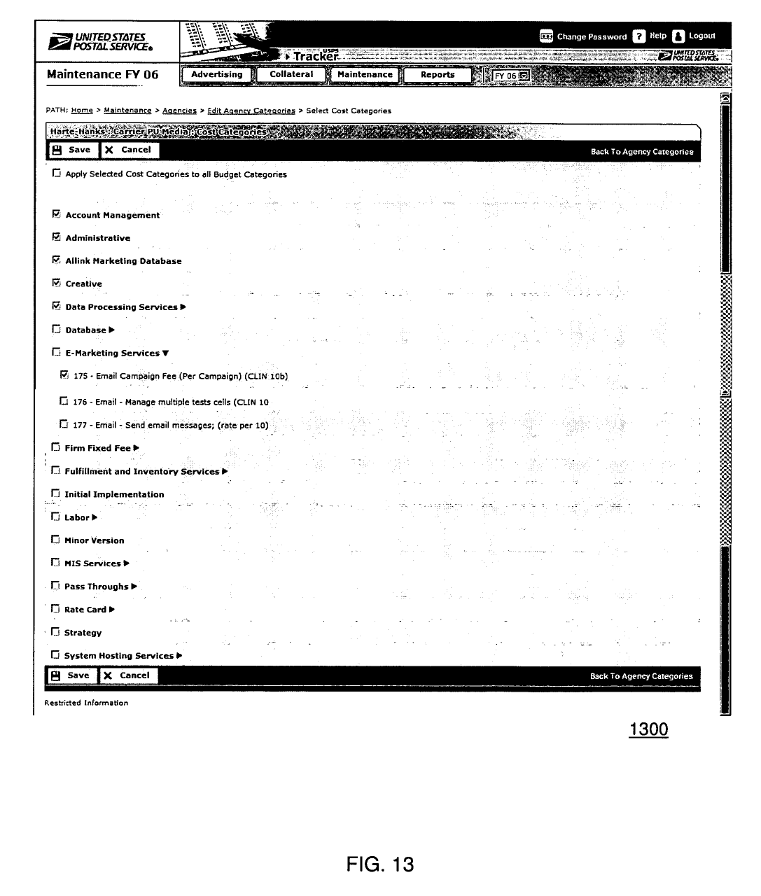

FIG. 13 is an exemplary edit cost categories interface 1300 displayed by the project management application when a managing user selects one of cost categories options 1206 corresponding to a particular agency from edit agency parameters interface 1200. Cost categories appearing on edit cost categories interface 1300 may be predefined by a managing user via cost categories option 806 on maintenance interface 800 without reference to any specific agency. In addition, cost categories may be defined to include hierarchal relationships. After defining each cost category, a managing user may select one or more cost categories displayed on edit cost categories interface 1300 to be associated with an agency. Thus, a database may associate cost categories with agencies in a many-to-many relationship.

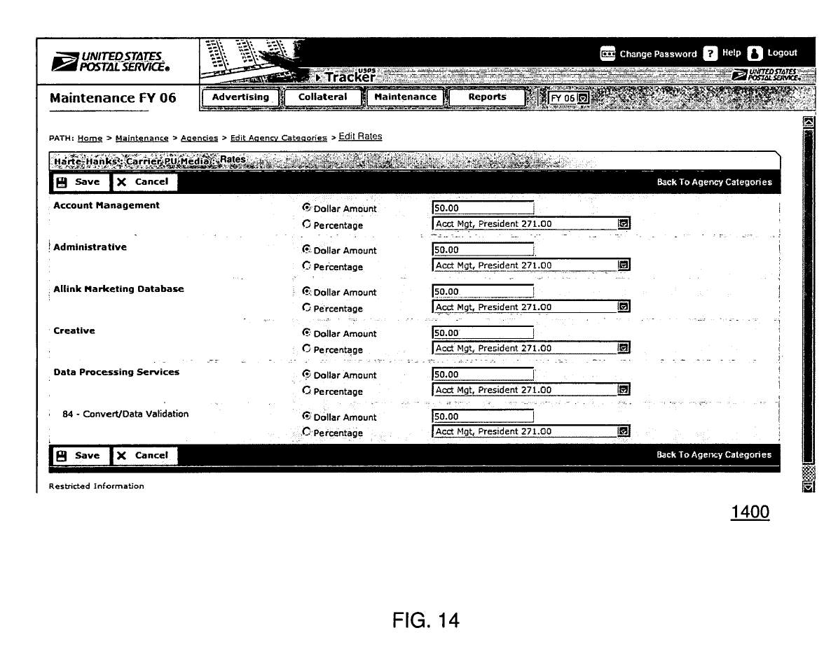

FIG. 14 is an exemplary edit rates interface 1400 displayed by the project management application when a managing user selects one of rates options 1206 corresponding to a particular agency from edit agency parameters interface 1200. Edit rates interface 1400 may permit a managing user to associate specific dollar or percentage billing rates with each cost category that was previously associated with the agency. In this manner, agencies may be associated with billing rates in a one-to-many relationship.

III. Reporting Module

The project management application may also include a reporting module, which may be used to permit a managing user to display specific groups of data from specific periods. The reporting module may permit selection from various report types, such as approved tasks report, invoice list report, or budget recap report, among others. The reporting module may also permit selection among various parameters to be used in generating the reports, such as agency, time periods, status levels, budget categories, etc. Reports may be displayed on a screen or optionally downloaded into a computer-accessible format for sharing electronically or for conducting further analysis.

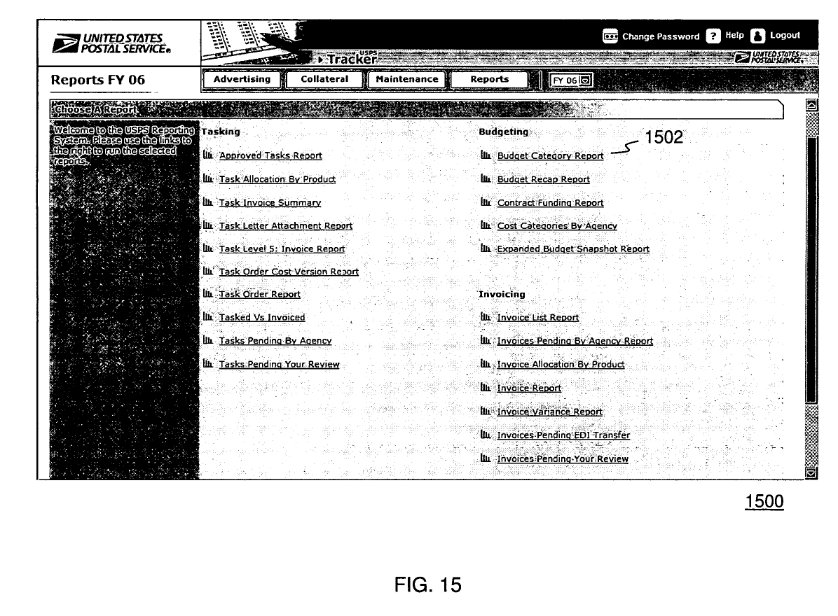

FIG. 15 is an exemplary reporting interface 1500 displayed by the project management application when a managing user selects report option 108 from main interface 100. Reporting interface 1500 may include various options that a user may select to run reports filtering and comparing various categories and types of data stored in the project management application's database. The exemplary reports shown on reporting interface 1500 are not an exhaustive list. For example, options and fields may be provided on reporting interface 1500 for a user to define and run new reports not included on reporting interface 1500.

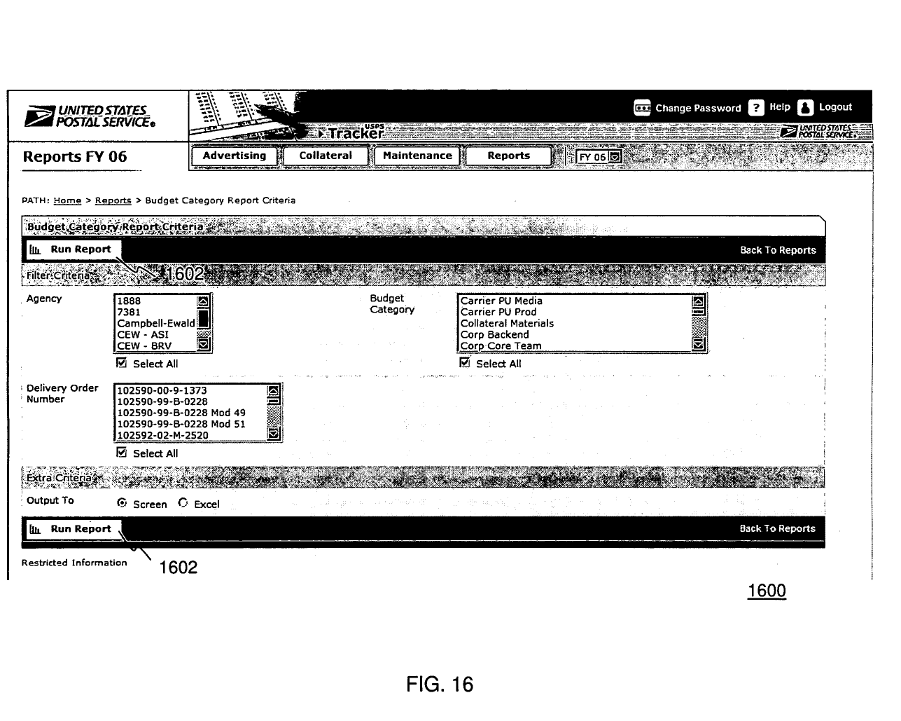

FIG. 16 is an exemplary report criteria interface 1600 displayed by the project management application when a managing user selects a budget category report option 1502 from reporting interface 1500. Report criteria interface 1600 may include options for a user to define report filter criteria. Report filter criteria may be defined by selecting one or more data categories, such as agencies, order numbers, budget categories, or other categories as applicable. In addition, a report format may be selected. Exemplary report formats may include screen (i.e., display on screen), Excel™, text, Adobe™ portable document, image, email, etc. A run report option 1602 may be selected by a user once the report filter criteria has been defined.

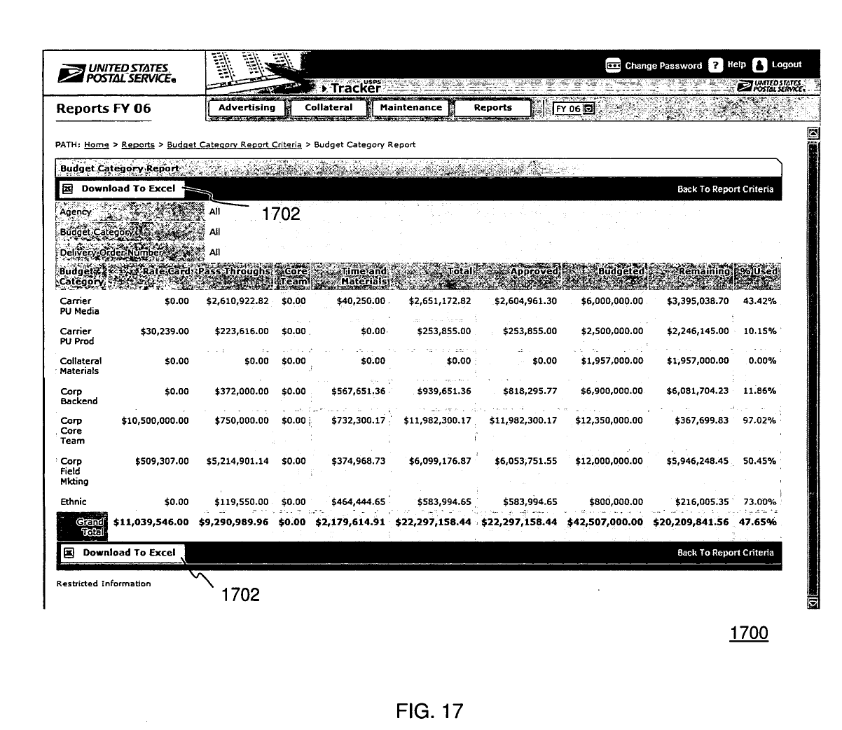

FIG. 17 is an exemplary report details interface 1700 displayed by the project management application when a managing user selects run report option 1602 from report criteria interface 1600. Report details interface 1700 may include one or more tables, each table including one or more rows and one or more columns of data. The data reflected in the tables may be processed data or raw data obtained from one or more databases used by the project management application for data storage. A managing user may download reports shown on report interface 1700 using a download option 1702. Although download option 1702 is depicted as downloading reports to Excel,™ report interface 1700 may include options for other download formats as well.

One of ordinary skill in the art will recognize that the interfaces and databases described in each of FIGS. 1 and 3-17 may have multiple panes, data, and options added, deleted, modified, reorganized, etc., without departing from the scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for managing projects in a database, the method comprising:
associating tasks with a project in a dependent many-to-one relationship; and
associating budget categories with the tasks in a one-to-many relationship.

2. The method of claim 1, further comprising:
associating resources with the budget categories in a non-specific relationship; and
associating the resources with the tasks in a one-to-many relationship.

3. The method of claim 2, wherein the resources comprise advertising labor resources.

4. The method of claim 1, further comprising:
associating deliverables with the tasks in a one-to-many relationship; and
associating products with the tasks in a non-specific relationship.

5. The method of claim 1, further comprising:
associating invoices with the tasks in a many-to-one relationship.

6. The method of claim 1, further comprising:
generating reports corresponding to at least one of the tasks, budget categories associated with the tasks, or invoices associated with the tasks, based on user-entered criteria.

7. The method of claim 1, further comprising:
receiving an invoice from a labour resource for work performed on at least one of the tasks;
receiving user-entered approval of the invoice; and
paying the invoice automatically.

8. The method of claim 1, further comprising:
revising at least one of the tasks or the budget categories, based on user input.

9. The method of claim 1, further including:
receiving a definition of at least one of the tasks from a labour resource; and
receiving user-entered approval of the at least one task.

10. The method of claim 1, further including:
associating customer segments with the project in a non-specific relationship.

11. A method for managing projects in a database, the method comprising:
associating resources with projects in a non-specific relationship;
associating the resources with cost categories in a non-specific relationship; and
associating the resources with rates in a one-to-many relationship.

12. The method of claim 11, further comprising:
associating rates of at least one of the resources with cost categories associated with the at least one resource.

13. The method of claim 11, wherein the rates associated with the at least one resource are associated with cost categories of the at least one resource in a one-to-one relationship.

14. An apparatus comprising:
a processor; and
a memory, the memory containing programs for managing projects in a database, which, when executed using the processor, perform steps comprising:
associating tasks with a project in a dependent many-to-one relationship; and
associating budget categories with the tasks in a one-to-many relationship.

15. An apparatus comprising:
a processor; and
a memory, the memory containing programs for managing projects in a database, which, when executed using the processor, perform steps comrpising:
associating resources with projects in a non-specific relationship;
associating the resources with cost categories in a non-specific relationship; and
associating the resources with rates in a one-to-many relationship.

16. A computer-readable medium containing instructions for performing a method of managing projects in a database, the method comprising:
associating tasks with a project in a dependent many-to-one relationship; and
associating budget categories with the tasks in a one-to-many relationship.

17. A computer-readable medium containing instructions for performing a method of managing projects in a database, the method comprising:
associating resources with projects in a non-specific relationship;
associating the resources with cost categories in a non-specific relationship; and
associating the resources with rates in a one-to-many relationship.

18. A method for managing projects in a database, the method comprising:
associating tasks with a project in a dependent many-to-one relationship;
associating budget categories with the tasks in a one-to-many relationship;
associating resource with projects in a non-specific relationship;
associating the resources with cost categories in a non-specific relationship;
associating the resources with rates in a one-to-many relationship; and
generating reports corresponding to at least one of the tasks, budget categories associated with the tasks, or invoices associated with the tasks, based on user-entered criteria.
